(19) United States
(12) Patent Application Publication
(10) Pub. No.: US 2016/0078138 A1
(43) Pub. Date: Mar. 17, 2016

(54) PORTAL FOR SHARING DATA OVER A NETWORK

(71) Applicant: Leigh M. Rothschild, Miami, FL (US)

(72) Inventor: Leigh M. Rothschild, Miami, FL (US)

(73) Assignee: Reagan Inventions, LLC, Bay Harbour, FL (US)

(21) Appl. No.: 14/950,241

(22) Filed: Nov. 24, 2015

Related U.S. Application Data
(63) Continuation of application No. 13/602,234, filed on Sep. 3, 2012.
Application No. 13/602,234 is a continuation-in-part of application No. 10/951,521, filed on Sep. 28, 2004, now abandoned.

(51) Int. Cl. G06F 17/30; G06Q 30/02; H04L 29/08

(52) U.S. Cl. CPC G06F 17/30867; H04L 67/02; G06F 17/30598; G06F 17/30339; G06F 17/30528; G06Q 30/0277

(57) ABSTRACT

A computer-implemented method performed within a portal server system is disclosed. A unique identifier and additional information associated with a party is received from the party. The unique identifier and additional information are stored within a storage device accessible by the portal server system. The unique identifier is received from a user accessing the portal server system. Access to the additional information is provided to the user based upon the unique identifier. The unique identifier consists of a telephone number associated with the party.

### CROSS-REFERENCE TO RELATED APPLICATIONS

This application is a continuation patent application of U.S. patent application Ser. No. 13/602,234, filed on Sep. 3, 2012 which is a continuation-in-part application of U.S. application Ser. No. 10/951,521, filed on Sep. 28, 2004. U.S. application Ser. No. 13/602,234 and U.S. application Ser. No. 10/951,521 are incorporated herein by reference in their entireties.

### BACKGROUND

1. Field

The present disclosure relates generally to data processing and communications systems, and more particularly, to methods and systems for managing communications of at least one client or user over a computer network. The methods and systems are implemented via a portal site and associated hardware, e.g., a portal server.

2. Description of the Related Art

Worldwide use of the Internet is growing at an extremely rapid pace. Millions of people worldwide use the Internet daily for accessing information, shopping, recreation, receiving product updates, and other communications. As computers and Internet access become less expensive and easier to use, use of the Internet will become even more widespread.

Many companies view the Internet as a profitable place to advertise their goods and services. Many web sites, especially “portal” sites (e.g., Yahoo!™, Google™, Excite™ and AOL™) that provide a starting point for browsing the web, are supported by selling advertising space on their web pages. The advertisements typically appear at the top or bottom of a web page, and are referred to as banner ads. Banner ads may be animated, and typically include a hypertext link that takes the user to the sponsor's web page when the user clicks on the banner ad.

At present, portal sites may charge anywhere from $25 to $60 or more per thousand times they display a sponsor's banner ad. Additionally, many portal sites on the web receive payment (up to several dollars) each time a user clicks on a sponsor's banner ad to go to the sponsor's web site. Many portal sites even receive a percentage of any transaction that results from a user transferring from the portal site to a commerce site. Selling advertisement space has proven extremely profitable for many portal sites.

There are many web portal sites that offer users “free” services in return for being able to display banner ads on the user's screen. These services include e-mail service, calendar and scheduling services, web space (typically, the user's web pages must display banner ads provided by the service), and other Internet services. The advantage to the company offering the portal site is that by offering compelling information and functionality they encourage user traffic to their site, i.e., they command large audiences and numbers of advertising viewers, and then can charge the advertisers (and sometimes the users) for accessing the site.

### BRIEF DESCRIPTION OF THE SEVERAL VIEWS OF THE DRAWINGS

For a more complete understanding of the nature of the present disclosure, reference should be had to the following detailed description taken in connection with the accompanying drawings in which:

FIG. 1 is a diagram of an exemplary portal system for managing communications of at least one client in a network in accordance with the present disclosure;

FIG. 2 is an exemplary portal server in accordance with the present disclosure;

FIG. 3 is a flowchart for illustrating a method for managing electronic mail, e.g., e-mail, in accordance with the present disclosure;

FIG. 4 is a flowchart for illustrating a method for managing content provided to at least one client in accordance with the present disclosure;

FIG. 5 is a flowchart for illustrating a method for enabling at least two clients to share an Internet experience in accordance with the present disclosure;

FIG. 6 is a flowchart for illustrating a method for providing expert guidance over a network in accordance with the present disclosure; and

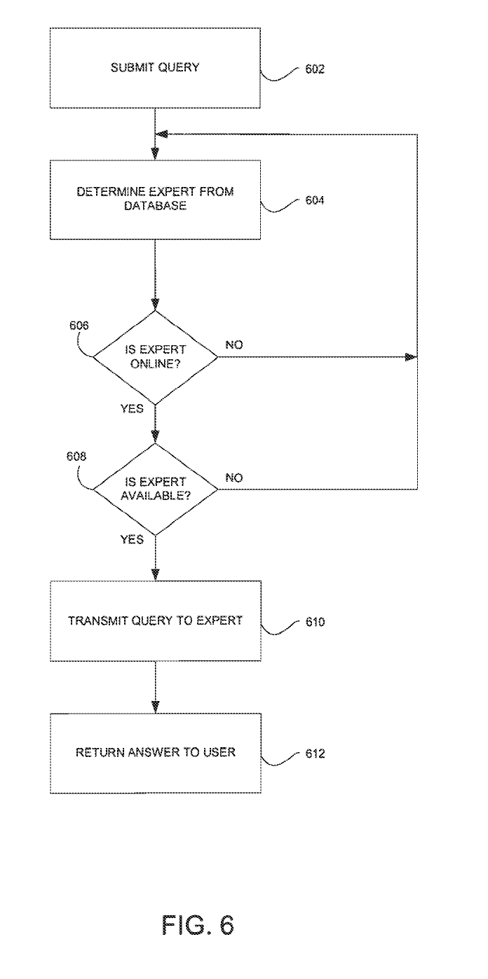

FIG. 7 is an exemplary screen shot of the expert search feature being employed in a word processing application in accordance with the present disclosure.

FIG. 8 is a flowchart for illustrating a method for sharing user data over a network in accordance with the present disclosure.

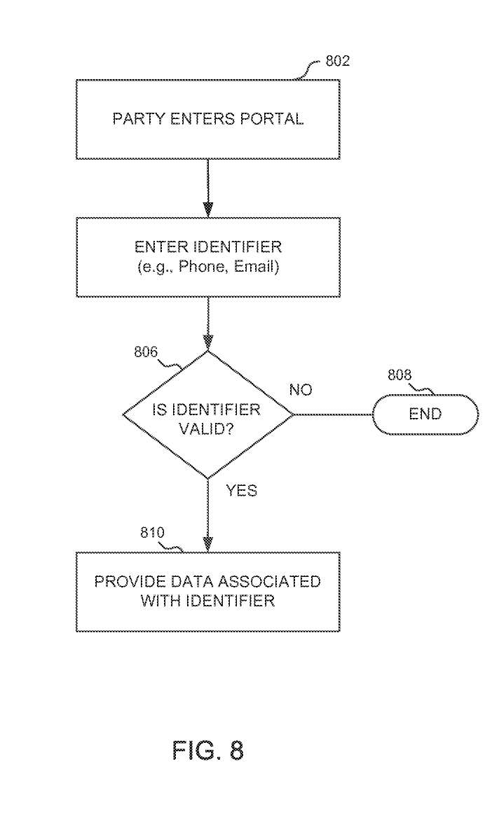

Like reference numerals refer to like parts throughout the several views of the drawings.

### DETAILED DESCRIPTION

In the following description, well-known functions or constructions are not described in detail to avoid obscuring the present disclosure in unnecessary detail.

Methods and systems for managing communications of at least one user, e.g., a client, over a network, e.g., the Internet, are provided. The methods and systems of the present disclosure are implemented via a portal web site running on an appropriate computing platform, e.g., a portal server. The portal will enable a user to communicate efficiently with other users, provide specific content to the user, enable a user to share a “surfing” session with another user and provide expert human guidance to user queries. In the following disclosure, the term “portal” will be used in interchangeable with the terms “portal site” and “portal server” to describe the mechanism to be a starting point or gateway for a user to communicate and/or explore over a global computer network, e.g., the Internet.

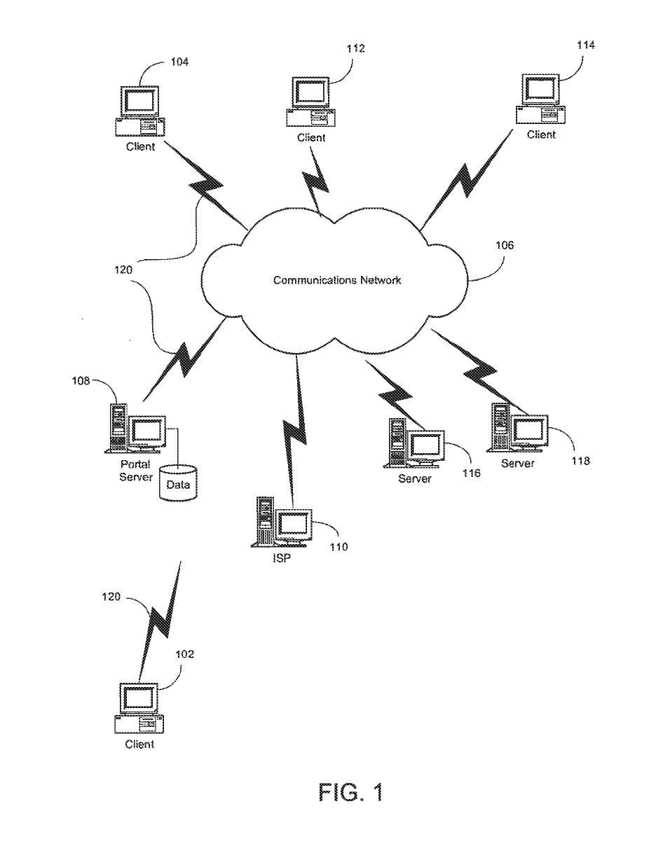

Referring to FIG. 1, an exemplary portal system for managing communications of at least one client in a network in accordance with an embodiment of the present disclosure is illustrated. As is known in the art, a user, e.g., client 102, may communicate with another user, e.g., client 104, over a communications network 106, e.g., the Internet. In certain aspects, client 102 will connect to the network 106 via portal server 108. In this manner, the portal server will manage communications of the client as will be described in detail below. Client 102 may connect to portal 108 by any known means for example hardwired or wireless. Alternatively, client 102 may connect to the network 106 via an Internet Service Provider (ISP) 110 and access the portal server by entering the appropriate domain name or Uniform Recourse Locator (URL) in an Internet browser, e.g., Internet Explorer by Microsoft Corporation. Once connected to the portal server 108, the portal server 108 will manage communication of client 102 to other users, e.g., clients 104, 112, 114, and/or manage the flow of information from various web sites connected to the network 106, e.g., content providers residing on servers 116, 118. Although the physical environment shows the connected devices as computers, such illustration is merely exemplary and may comprise various digital devices, such as PDAs, network appliances, notebook computers, etc. The computing devices may communicate to the servers 108, 110, 116, 118 and network 106 via any known communication link 120, for example, dial-up, hardwired, cable, DSL, satellite, cellular, PCS, wireless transmission (e.g., 802.11a/b/g, Bluetooth), etc. Furthermore, the devices will communicate using the various known protocols such as Transmission Control Protocol/Internet Protocol (TCP/IP), File Transfer Protocol (FTP), Hypertext Transfer Protocol (HTTP), etc.

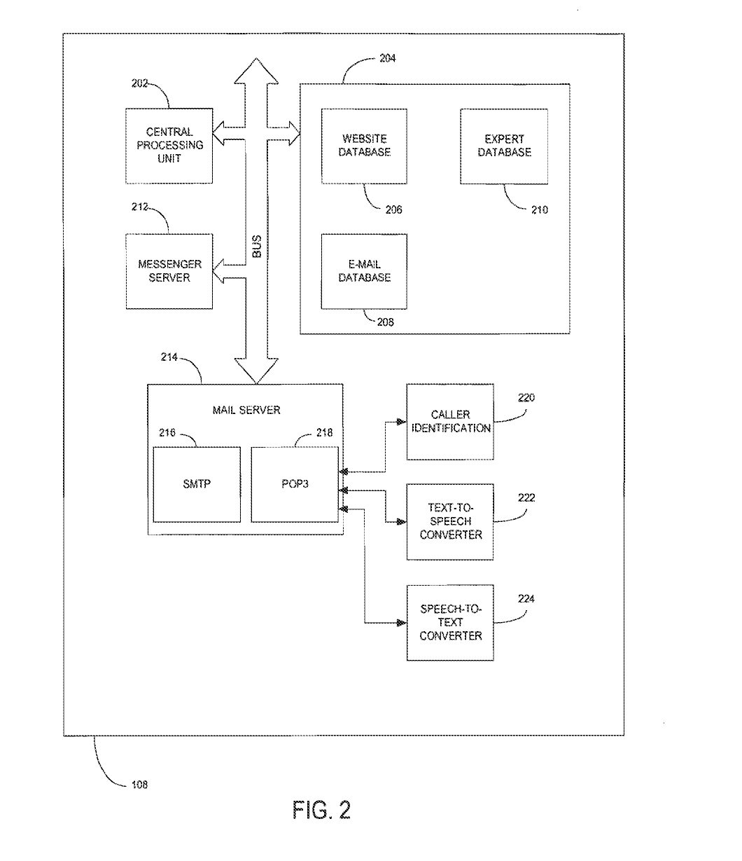

Portal server 108 will enable the various functions and features of the portal site and facilitate communications among users. Referring to FIG. 2, a portal server according to one embodiment of the present disclosure is illustrated. The portal server 108 includes a central processing unit (CPU) 202 for controlling the overall operations of the components of the server, for indirectly controlling the flow of data in and out the server and controlling communications between the portal server and various clients and/or users. The CPU 202 may be embodied as a terminal server as in known in the art. The portal server 202 further includes a plurality of relational databases 204 including a website database 206, an e-mail database 208 and an expert database 210, the functions of each will be described in detail below. Additionally, the portal server 108 will include a messenger server 212 for handling instant messaging communication as is known in the art.

Furthermore, the portal server 108 will include a mail server 214 for handling electronic mail, e.g., e-mail. The mail server 214 will include the appropriate applications and/or servers for handling incoming mail, e.g., Simple Mail Transfer Protocol (SMTP), and outgoing mail, e.g., Post Office Protocol 3 (POP3). The mail server 214 will interact with further subsystems to enable certain functionality of the portal site. These subsystems may include but are not limited to a caller identification system 220 for determining the identity of a user accessing the portal server via a Plain Old Telephone System (POTS), a text-to-speech converter 222 for audibly producing e-mail messages to a user of the portal and a speech-to-text converter 224 for converting a user's spoken words to digital text for inserting into an e-mail message. These subsystems will be described in more detail below in relation to the operations of the portal site.

It is to be understood that the present invention may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine comprising any suitable architecture such as a personal computer, Portable Data Assistant (PDA), a mobile device, a workstation or server. In certain aspects, the machine is implemented on a computer platform having hardware such as one or more central processing units (CPU), a random access memory (RAM), a read only memory (ROM) and input/output (I/O) interface(s) such as a keyboard, cursor control device (e.g., a mouse or joystick) and display device. A system bus couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform by various interfaces and bus structures, such as a parallel port, serial port or universal serial bus (USB or Firewire (1394)), for example, additional storage devices and a printer.

It is to be further understood that because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

It is to be appreciated the portal server will operate in a networked environment using logical connections to one or more remote computers as shown in FIG. 1. The remote computers 104, 112, 114, etc. may be a personal computer, a Portable Data Assistant (PDA), a mobile device, a server, a router, a mainframe, a network PC, a peer device or other common network node, and typically includes many or all of the elements described above. It is to be appreciated that the network 106 may be a local area network (LAN), wide area network (WAN), wireless network, the Internet or any known network that couples a plurality of computers to enable various modes of communication via network messages. For example, the network environment may be a corporate intranet including a single server and multiple personal computers housed within a single facility, or alternatively, multiple servers with multiple personal computers located in various geographic locations.

The various functions of the portal server implemented through various forms of software and hardware will now be described.

Accessing and Assigning E-mail:

A user will have the opportunity to sign up with the portal to have e-mail access. This access will allow the user of the portal to both send and receive e-mail. The users address will uniquely be defined as their home, cellular, or business phone number at the portal's domain, for example 9543211234@portal.com. The user will be able to check their e-mail at any time that they are connected to the portal by clicking on an icon that will be in their desktop tray. The user can also check their e-mail through conventional e-mail clients such as Microsoft™ Outlook or Outlook Express, AOL™ Mail, etc. The use of a phone number as an e-mail address is unique and allows individuals to remember users e-mail by correlating it with their phone number. By example, if a person has another person's phone number he can then attempt to contact the portal user by phone or also by using the phone number prefix as the e-mail address.

The portal owner or administrator will use their master domain account to assign sub-e-mail addresses to their subscribers. Customarily, a domain address allows assignment of any prefixes that the owner desires. In this case, the portal owner will assign the telephone number that the subscriber registers and requests as the e-mail prefix. In other words, if the domain name of the portal is subjectdomain.com, the portal server would assign as e-mail addresses 1234567890@subjectdomain.com where 1234567890 represents one of the users telephone numbers. The portal server will store the assigned e-mail address and other user information in the e-mail database 208 as shown in FIG. 2. Additionally, the portal will allow the user to associate an existing e-mail address or addresses with their phone number. In that way, the portal may determine the portal user's e-mail identity simply by a user entering a phone number of an intended recipient.

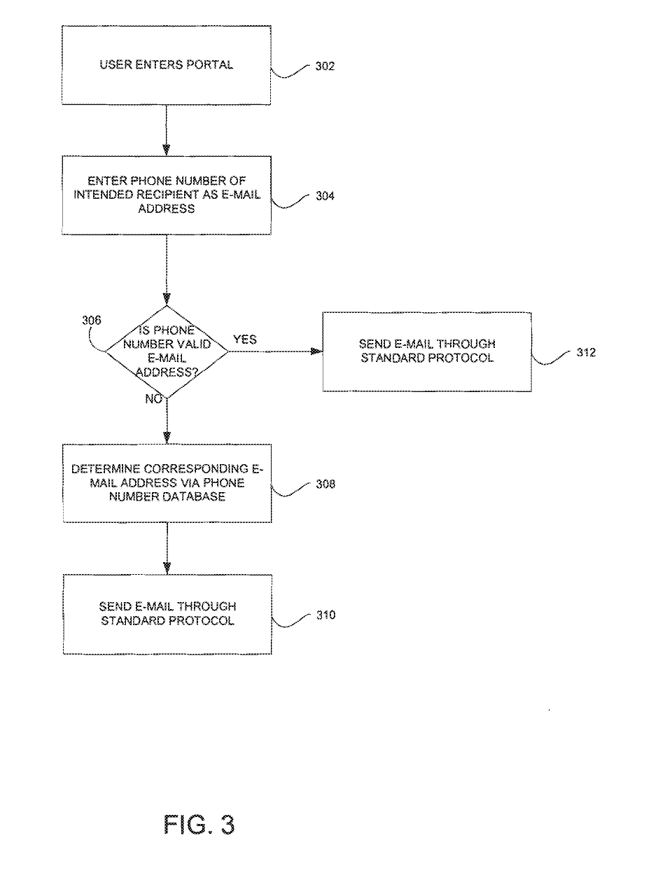

Referring to FIG. 3, a method for managing e-mail by portal server 108 is illustrated. In step 302, a user of the portal will enter the portal by either directly connecting to the portal server or via an ISP by launching an Internet browser and entering the appropriate portal domain name. The user will enter the phone number of the intended recipient, step 304 and the client computer will then communicate to the SMTP server 216 of the mail server 214 to determine if the e-mail address is valid (step 306). If the e-mail address is valid, the SMTP server 216 will send the e-mail through standard protocol as is known in the art to the intended recipient (step 312). Otherwise, the SMTP server 216 will access the e-mail database 208 to determine if a corresponding e-mail address is available (step 308). If a corresponding e-mail address is available, the processor 202 of the portal will reconfigure the e-mail to include the corresponding e-mail addresses and pass the e-mail back to the SMTP server 216 to be forwarded to the intended recipient. The recipient of this information could attempt to e-mail the portal user either through conventional e-mail channels (e.g. Outlook, AOL, etc.) or alternatively could log on to the portal and simply type on the portal users phone number and then be allowed to e-mail the portal user.

The user will also have the option of checking for his e-mail by telephone. The user would simply request by phone to receive their e-mail messages either through a coded tone response (tone dialing) or with their voice. For example, the user may dial a portal access telephone number provided by the portal operator. In one embodiment, the caller identification system 220 will recognize the telephone number of the user by conventional caller ID technology. The recognized telephone number is then used by the processor 202 to determine the user via the e-mail database 208. Alternatively, the user may speak their name and speech-to-text converter 224, employing conventional voice recognition software, will convert the user's name into digital form which then again can be compared to the e-mail database 208 to determine the user. Once the user has been determined, the processor 202 will hand control over to the POP3 server which holds incoming e-mail messages for the user. If there are messages for the portal user, then these messages could be played back to the user using the text-to-speech converter 222. The user could also reply (from their telephone) to these e-mail messages by means of common voice recognition (speech-to-text) technology via speech-to-text converter 224 to create a text e-mail message, or the user could reply by text using standard e-mail systems including Outlook™, AOL™, etc.

Issuance of specific Website Addresses:

Another feature that the portal will offer its customers will be the issuance of specific website addresses. One of the problems on the Internet is that if you wish to register an Internet domain name for your website that name may be gone. The portal of the present disclosure will solve that problem by issuing their own domain names to its users with a prefix to its domain site. In other words, if the user wants the domain name “South Beach”, he would request it from the portal and they would assign the address “South Beach” to the user by linking these keys words to the user's existing web site through a URL or issue the user a new URL and save the links in website database 206. When another person wants to get to the users website, e.g., South Beach, he would merely go the Portal's website (e.g., www.portal.com) and then type in ‘South Beach’ in an appropriate search field or, alternatively, he could type www.portal.com/SouthBeach. The user would then be taken to the website that contains the content for ‘South Beach’.

The portal owner will use their server(s) to set up a database of subscriber requested websites, e.g., website database 206 as shown in FIG. 2. For instance, if the subscriber requests the website South Beach, the server will set up a relational database that will list the subscriber's name, along with the requested web name South Beach, along with the corresponding web address (URL) for that web name. In this case the web address could be a customer supplied web address such as www.southbeachhotspots.com or it could be a portal assigned web address such as www.portalassignedaddress.com/Southbeach (where portalassigneddaddress is the actual domain name of the portal).

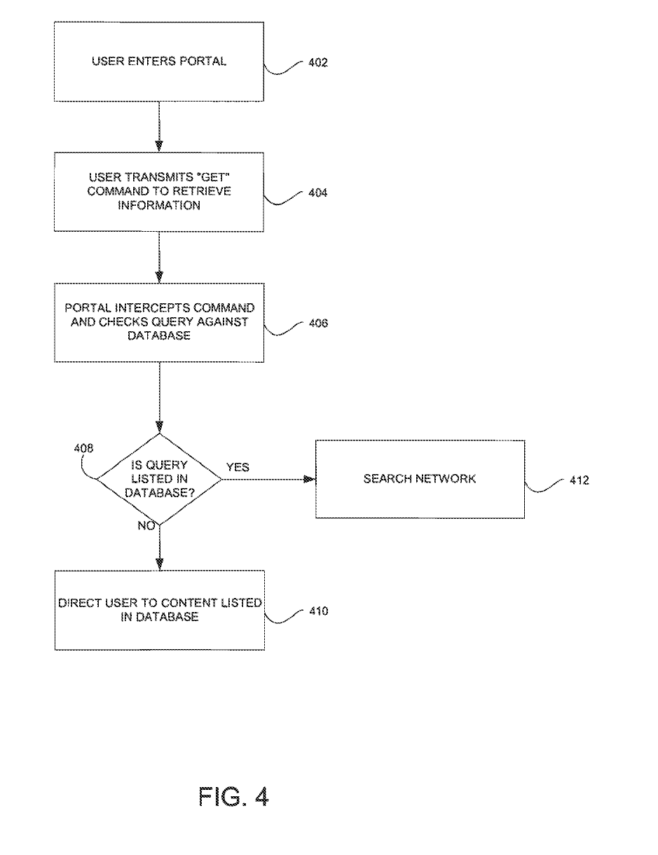

Referring to FIG. 4, the portal server(s) 108 will act as a global switch in that any user on the Internet will be able to reach the portal website address (step 402) and on that site will find a request/query form that will allow the portal user to type in the name of the website that they are looking for (step 404). This request will result in transmitting an Internet protocol “GET” command, as is conventionally known, that will attempt to find the appropriate web site. However, before searching the Internet, the portal server will intercept this command then submit this user request to its relational database which will attempt to match the requesting query to the database information (step 406). The server will then determine if the requested query is listed in the database 206 (step 406). If the subject of the query is in the database 206, the server will then return the response from the database (step 410). In the previous example, the query for SouthBeach would return the URL address of www.southbeachotspots.com and the portal user would be redirected by means of a standard web hyperlink to this site. Otherwise, the portal server will transmit the GET command over the Internet and find the appropriate web site (step 412).

In this manner, the portal administrator will have the ability to allow portal users to register for website names previously not available address that he can now distribute to the public. The portal owner is happy because the only way other users can get to these website addresses is to pass through the portal's servers. The portal may also have a revenue source by charging to assign these unique web addresses.

Sharing of Internet Experience Among Users:

Another feature that the portal will offer its users is the ability to allow other individuals that are in different locations to effortlessly join and share in their Internet experience. If a portal user is accessing the Internet, and they decide that they want another person or persons to join their explorations, they will be able to communicate to the other person through e-mail, instant messaging, or any other type of communication, and the other person(s) will be notified that portal user #1 wants this person to join them.

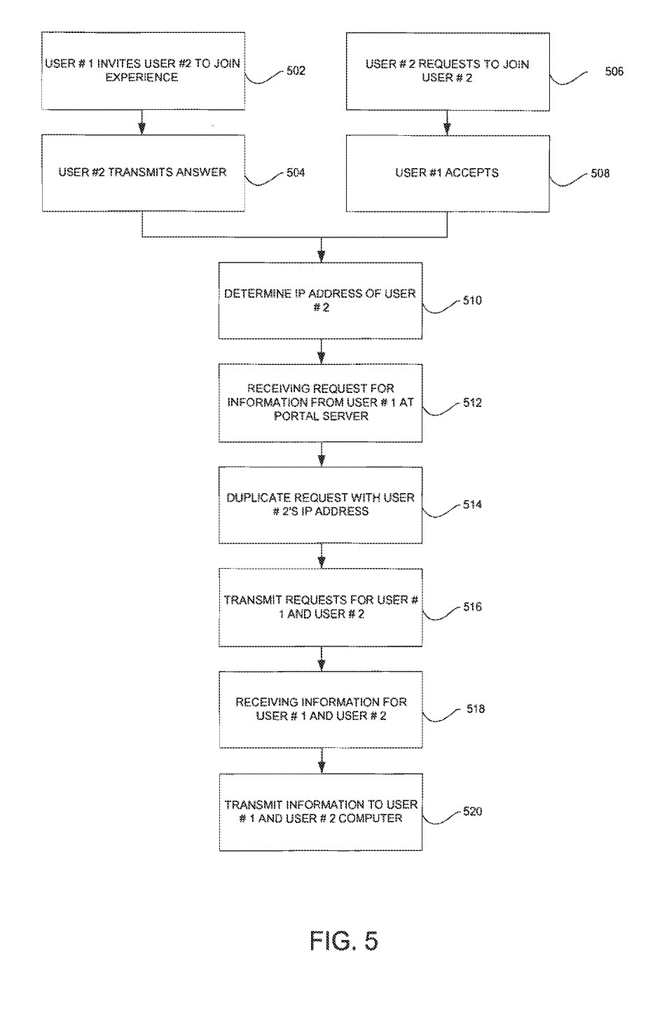

Referring to FIG. 5, a method for enabling at least two users to share an Internet experience is illustrated. Initially, user #1 may invite user #2 to share an Internet experience (step 502). It is to be appreciated that “sharing an Internet experience” means that user #2 will see on their computer the same information and websites user #1 views, as if the users were sitting side-by-side viewing the same monitor of a computer system. User #1 may extend this invitation through e-mail or instant messaging or voice over data (e.g., VoIP) to user #2. Users #2 will then transmit their answer to user #1 of whether they will join (step 504). Alternatively, user #2 may initiate the request to join with user #1 (step 506). In that user #2 initiates the request, user #1 must accept before user #2 can be joined (step 508).

Once this connection has been authorized by portal user #1, the portal server 108 will determine the IP address of user #2 (step 510). For example, if instant massaging was used between the users, the messenger server 212 of portal server 108 will extract the IP address of user from user #2′s instant message. Furthermore, if e-mail was employed for communications between the users, mail server 214 will determine the IP address of user #2, or alternatively, the portal server 108 will determine the IP address from the e-mail database 208 if user #2 is a member of the portal.

Next, the portal server 108 will receive a request for information from user #1 (step 512), e.g., the user may have to enter a URL of a desired website. Before transmitting the request, the portal server 108 will duplicate the request with user #2's IP address (step 514) and transmit both requests (step 516). In essence, the portal server is sending out two requests as if they were individually sent from each user. The portal will then receive the requested information (step 518) and will transmit the information to both user #1 and user #2 (step 520).

This functionality will allow portal user #2 to view whatever content portal user #1 goes to as he moves around the global computer network. This would also apply to multiple users so that if portal user #1 wanted to invite 100 other users to sign on to the portal and be connected, Portal User #1 could then direct them to various sites/content on the Internet. Moreover, Portal User #1 would have the opportunity at any time to allow any other user to take control of the website selections and then control would switch to that designated individual. During the access of the Internet content by one or more persons, those users would still have the opportunity to chat while viewing content by means of Internet telephony, instant messaging, or any other communication choice that would be available.

As a member of the portal, this feature will allow the portal user to have various sessions where he can use this feature for general community education, entertainment, games, distance learning or other functionality. The portal owner is pleased with this feature because they will receive more Internet site traffic as users sign on to join other individuals to together explore Internet content.

Expert Live or Delayed Human Guidance:

Another feature that the portal will offer is the ability to receive ‘expert’ live or delayed human guidance with one click of a button in response to Internet search queries. Conventional portals (e.g., Yahoo!™, Google™, Ask Jeeves™) offer the ability to concisely search the Internet for answers to queries but do not allow the ability to instantly seek out human intelligence. The portal of the present disclosure will offer a service where the user can type in a question, e.g., a query, and the question will be intelligently routed to other volunteer users of the portal who will provide assistance to the querying user.

In certain aspects, the portal owner will provide a website page where the portal user will be able to enter search queries (step 602). These queries may be in the form of questions for instance, “What was Tom Clancy's first Novel”. Optionally, the portal user who submits the query would indicate the category and subcategory that the query is in, or alternatively, using computer processing and logic the portal server will identify the query and attempt to place it in a category, saving the portal user the time of entering the information. In this subject case for Tom Clancy, the query would be classified as Category: Literature, subcategory: Modern Novels. The portal server will then submit this query to the expert database 210 which will process and return an answer as to which portal user(s) have previously registered with the database as an ‘expert’ in the query subject area (step 604). The relational database 210 would be previously populated by portal users who have registered to be experts. In this example, a person may have registered to be an expert in the area of Literature, subcategory Modern Novels. Through standard programming and computer processing, the relational database will return the closest results of an expert who matches the query submission. In the case where there is not an exact match (for instance, no experts exist in the category of Modern Novels but there are experts in the category of Literature), the relational database will return the closest results.

The portal server will next determine which of the selected experts that met the search criteria are online (step 606) and available at the moment of the query (step 608). Although an expert may be online, the expert may have indicated that they cannot be disturbed at the present time; in analogy, to the “Do not Disturb” feature of conventional instant message. The portal server may elect to only route the question to those experts who are available to immediately answer the question (or alternatively, if the information requestor indicates that the answer is not time sensitive, off-line users could be contacted by the server and they would answer at a later point in time.) The means of contact from the portal server to the expert portal user could be a dialogue box that appears on the expert portal user's screen, an icon that appears in the expert portal user's computer's ‘tray’, an e-mail to the expert portal user, an instant message to the expert portal user or any other method of communication that the portal user has asked to be used or is otherwise available now or in the future for one global computer network (e.g., Internet) user to contact another user. The query is then transmitted to the expert through their preferred means of communication (step 610).

After the expert portal user is contacted by the means specified above, he will then communicate his answer back to the portal server through the global computer network, and that answer would be instantly and anonymously transmitted to the information requestor (step 612). By example, to the query “What was Tom Clancy's first novel?”, the expert portal user would reply “Hunt for Red October”. Of course, the expert portal user may reply incorrectly, or point the requesting user to another source for the answer, or offer additional solicited or unsolicited comments.

Another feature of the present disclosure is that the query from the portal user may result in the portal server putting the user in touch with multiple portal user ‘experts’ who would then return to the portal user many answers. Moreover, if the portal ‘expert(s)’ wanted to provide their contact information (for example, Instant Message screen name, e-mail, website, phone number, postal service, etc.) the portal information requestor and the ‘expert’ could then start a dialogue. In certain aspects, most responses that are sent would be on an anonymous basis.

This human expert intelligence network is extremely powerful, because the Internet allows hundreds of millions of people to simultaneously communicate, and the ability of using that communications vehicle to provide assistance from one portal user to another is a very valuable tool to provide information that goes well beyond published website searches.

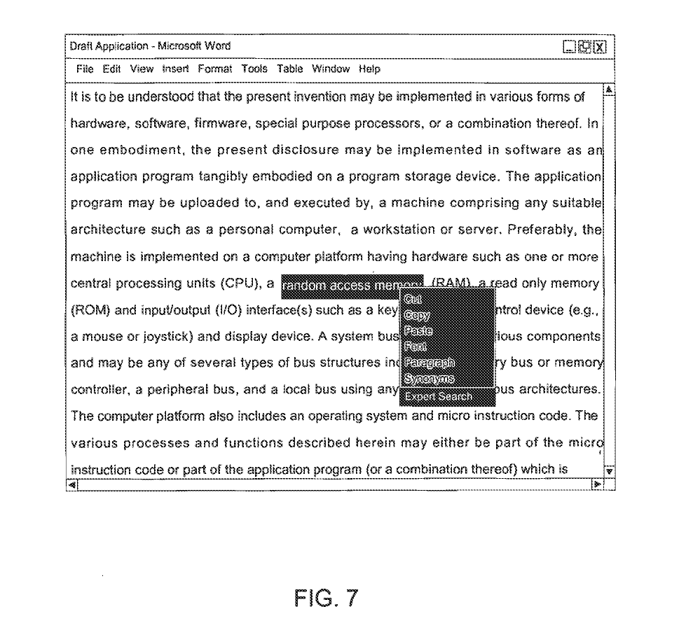

Another feature that the portal will offer is the availability to use the expert search as described above when accessing other applications. To utilize the search feature while in other applications, the portal will provide an application program or plug-in to run in the background on a user's computer while the user is working in the other application. The background program will generate a query request which will be sent to the portal and processed by the expert guidance system described above. By example, if a portal user were working on a word processing document using standard word processing software and the portal user needed information on any term or terms in the document, the portal user could highlight those selected subject words and then request the portal to provide a search. Once the words are highlighted, the user will right-click on the highlighted words with a pointing device, e.g., a mouse, to open an action box, as shown in FIG. 7. Along with the conventional options such as cut, copy, paste, etc., ‘Expert Search’ will be an option in the action box. By selecting the Expert Search option, the portal user's computer will transmit a message to the portal server that it wishes to access the expert search feature. The portal user's computer will then submit the selected search terms to the portal server as the query terms that it wished the portal server to utilize to process the expert search.

The portal would then search the highlighted terms using either the expert search mode procedure and protocols described in the paragraphs above, or via a conventional search of Internet web pages. The full features of the portal will be available from any computer application included but not limited to word processing, web page browsing applications, computerized spread sheets, PowerPoint or slide show presentations, audio media content, or any other computer program that the portal user may have access to locally or through the global computer network.

While the invention has been shown and described with reference to certain embodiments thereof, it will be understood by those skilled in the art that various changes in form and detail may be made therein without departing from the spirit and scope of the disclosure as defined by the appended claims.

More in particular, because the digital media file 60, for purposes of the illustrative implementation shown in FIG. 4, is initially disposed on the media node 30, the digital media file 60 may be transmitted, i.e., “pushed” or “pulled”, to the media terminal 20 from the media node 30 via the communication link 70. In particular, the media terminal 20 may display the digital media file 60, save the digital media file 60, and/or manipulate or edit the digital media file 60. In addition, the media terminal 20, in at least one embodiment, may be structured to transmit the digital media file 60 and/or the edited media file back to the media node 30 via the communication link 70.

Sharing User Data

Another feature that the portal server system can provide its users is the ability to share data associated with one particular user to other users of the portal server system. Frequently, when one party meets another party in a business and/or social setting, certain contact information is exchanged with the intention that these parties will subsequently contact one another. This exchange of information can include, for example, the exchange of business cards, phone numbers, email addresses, and/or other information associated with the respective parties. The terms “party”/“parties” and “user”/“users” are used herein for purposes of explanation and can refer to any type of entity, such as people, businesses, corporations, non-profits, and organizations.

Although the information is exchanged between the parties, a problem recognized by the inventor is that this information is oftentimes insufficient for one or all of the parties. For example, one of the parties may feel the need to obtain more information about the other party before initiating subsequent contact. The portal server system of the present disclosure addresses this problem by providing one party with easy access, via the portal server system, to additional information associated with the other party.

Referring again to FIG. 2, one party enters information about the party into the portal server system 108. This information may include, but is not limited to, contact information (e.g., telephone number, email address, work address, home address, fax number), an electronic business card (e.g., a vCard), social networking information (e.g., links to the user on social networking sites such as Twitter™, Facebook™, and Linkedln™), and other documents (such as text files, word processing files, image files, video files, audio files as well as streaming versions of these files). Examples of this additional information would be a resume or a sales pitch. This additional information is then saved into the database 206 or any other storage system accessible by the portal server system 108.

The party also can choose to enter into the portal server system 108 a unique identifier to be associated with the party. For example, the unique identifier may be a telephone number associated with the party, an email address associated with the party, or any other identifier that can be used to uniquely identify the party.

In certain aspects, the portal server system 108 can confirm that the party is associated with the either the email address or the telephone number by sending a verification email to the email address or a verification text message or audio message to the telephone number. This verification email/message can contain information that can be entered into the portal server system 108 by the party to verify that the party is, in fact, associated with the respective email address or telephone number. Once the unique identifier has been established for a particular party, this unique identifier may also be stored in the database 206 or any other storage system accessible by the portal server system 108 and associated with the stored additional information.

Referring to FIG. 9, the portal server(s) 108 acts as a gateway through which a user may obtain information about the party. In operation, the party gives certain contact information to the user, and this contact information includes the unique identifier or information from which the unique identifier can be derived. For example, the party's business card may have both the party's phone number and email address—either of which could serve as the unique identifier. In 802, the user accesses the portal server system. In 804, the portal server system provides the user with the ability to provide the unique identifier. After the unique identifier has been provided, in 806, a determination is made whether or not the unique identifier is valid.

In 808, if the unique identifier is not valid, an error condition results and the process is ended. However, if the unique identifier is valid, in 810. the user is provided access to the additional information that the party previously associated with the unique identifier and stored within the portal server system. In this manner, for example, the party can obtain additional information, via the portal server system, about the user from just the unique identifier.

What is claimed is:

1. A method, comprising:
receiving, by the computer server, an expert search query from a user computing device;
determining, by the computer server, one or more categories of expertise for the expert search query;
determining, by the computer server, an expert and expert contact information based on the one or more categories of expertise;
transmitting, by the computer server, the expert search query to an expert computing device based on the expert contact information;
receiving, by the computer server, a response to the expert search from the expert computing device;
transmitting, by the computer server, the response to the expert search to the user computing device.

2. The method of claim 1, further comprising:
receiving, by the computer server, contact information and at least one category of expertise for each of one or more experts from one or more expert computing devices;
storing, by the computer server, the contact information for each of the one or more experts in a database based on the at least one category of expertise.

3. The method of claim 1, further comprising transmitting, by the computer server, expert contact information to the user computing device.

4. The method of claim 1, further comprising exchanging, by the computer server, one or more messages based on at least one of the expert search query and response to the expert search query between the user computing device and the expert computing device.

5. The method of claim 4, wherein the one or more messages is at least one of an email message, instant message, text message, voice message, and video message.

6. The method of claim 1, wherein the expert search query is based on one or more terms indicated by a user application running on the user computing device.

7. A computer server, comprising:
a database;
a processor coupled to the database, wherein the processor is configured to:
receive an expert search query from a user computing device;
determine one or more categories of expertise for the expert search query;
determine an expert and expert contact information based on the one or more categories of expertise;
transmit the expert search query to an expert computing device based on the expert contact information;
receive a response to the expert search from the expert computing device;
transmit the response to the expert search to the user computing device.

8. The computer server of claim 7, wherein the processor is further configured to:
receive contact information and at least one category of expertise for each of one or more experts from one or more expert computing devices;
store the contact information for each of the one or more experts in a database based on the at least one category of expertise.

9. The computer server of claim 7, wherein the processor is further configured to transmit expert contact information to the user computing device.

10. The computer server of claim 7, wherein the processor is further configured to exchange one or more messages based on at least one of the expert search query and response to the expert search query between the user computing device and the expert computing device.

11. The computer server of claim 10, wherein the one or more messages is at least one of an email message, instant message, text message, voice message, and video message.

12. The computer server of claim 7, wherein the expert search query is based on one or more terms indicated by a user application running on the user computing device.

13. A system, comprising:
a computer server having:
a database;
a processor coupled to the database, wherein the processor is configured to:
receive an expert search query from a user computing device;
determine one or more categories of expertise for the expert search query;
determine an expert and expert contact information based on the one or more categories of expertise;
transmit the expert search query to an expert computing device based on the expert contact information;
receive a response to the expert search from the expert computing device;
transmit the response to the expert search to the user computing device.

14. The system of claim 13, wherein the processor is further configured to:
receive contact information and at least one category of expertise for each of one or more experts from one or more expert computing devices;
store the contact information for each of the one or more experts in a database based on the at least one category of expertise.

15. The system of claim 13, wherein the processor is further configured to transmit expert contact information to the user computing device.

16. The system of claim 13, wherein the processor is further configured to exchange one or more messages based on at least one of the expert search query and response to the expert search query between the user computing device and the expert computing device.

17. The system of claim 16, wherein the one or more messages is at least one of an email message, instant message, text message, voice message, and video message.

18. The system of claim 13, wherein the expert search query is based on one or more terms indicated by a user application running on the user computing device.

19. The system of claim 13, further comprising a user computing device configured to transmit the expert search query wherein the expert search query is generated based on a term used in a user application running on the user computing device.

20. The system of claim 14, further comprising an expert computing device configured to transmit at least one category of expertise wherein the at least one category of expertise is based on background of the one or more experts.
